(19) United States
(12) Patent Application Publication
(10) Pub. No.: US 2014/0173714 A1
(43) Pub. Date: Jun. 19, 2014

(54) INFORMATION PROCESSING APPARATUS, AND LOCK EXECUTION METHOD

(71) Applicant: FUJITSU LIMITED, Kawasaki-shi (JP)

(72) Inventor: Makiko NAKAO, Kawasaki (JP)

(73) Assignee: FUJITSU LIMITED, Kawasaki-shi (JP)

(21) Appl. No.: 14/094,453

(22) Filed: Dec. 2, 2013

(30) Foreign Application Priority Data
Dec. 14, 2012 (JP) 2012-273772

(51) Int. Cl. G06F 21/31; G06F 21/62

(52) U.S. Cl. CPC G06F 21/31; G06F 21/62
USPC 726/16

(57) ABSTRACT

A lock execution method for information processing apparatus, includes performing a first authentication based on input information from a user after an application of a power source, preparing authentication information for a second authentication to be corresponded to the input information after the first authentication succeeds, performing the second authentication using the prepared authentication information, issuing a command to execute a lock operation for the information processing apparatus after the second authentication by the authentication succeeds, and invalidating at least some of content of manipulation input during a period time until the lock operation is completed after the command is issued at the issuing.

### CROSS-REFERENCE TO RELATED APPLICATION

This application is based upon and claims the benefit of priority from the prior Japanese Patent Application No. 2012-273772 filed on Dec. 14, 2012, the entire contents of which are incorporated herein by reference.

### FIELD

The present disclosure relates to an information processing apparatus that executes lock of a computer, a lock execution method and a lock execution program.

### BACKGROUND

Operating Systems (OS) such as Windows (registered trademark) have been installed in conventional computers such as Personal Computers (PCs). Conventionally, when a user activates the OS to log on to the computer, plural built-in programs or programs pre-registered in a start-up (hereinafter, referred to as “activation program”) in advance are started to run sequentially. Therefore, the performance of the PC is degraded such that the manipulability is degraded as well and thus, the user may not work pleasantly.

Further, there has been a case where the user logs on to the Windows right after the user goes to the office in the morning and then, leaves his seat to attend, for example, a meeting, and makes the activation program run while the user is attending the meeting in order to effectively utilize the busy time in the morning.

However, when the user leaves his seat while a manipulation screen (hereinafter, referred to as “user desktop”) of the Windows is in an active state after the user logs on to the Windows, there is a possibility that the PC may be used fraudulently by a third party. In order to avoid such a situation, there is an operative case where the user performs a predetermined keyboard manipulation (e.g., concurrently depressing “Windows logo key” and “L key”) to lock the PC before the user leaves his seat. Further, when the user comes back to his seat, the user may perform a lock releasing manipulation.

Further, there exists a scheme in which a user identifier is received and notified to an architecture configured to grant an access for encrypted data or a part of the computer to the particular user, and the lock for the encrypted data or the part of the computer is released. Also, there is a scheme in which the lock is released with a biometric authentication using, for example, a finger vein pattern or a fingerprint. There is yet another scheme in which manipulations other than a predetermined manipulation are prohibited after login to the OS is ended or after the OS is activated. See, for example, Japanese Patent Application Laid-Open No. 2009-301543, Japanese Patent Application Laid-Open No. 2007-148950, Japanese Patent Application Laid-Open No. 2011-141607, and Japanese Patent Application Laid-Open No. 2011-118936.

However, in the conventional schemes as described above, for example, the user performs a lock manipulation after completing the login to the OS and thus, the user is required to wait until the OS is activated. Accordingly, there is a chance that the user may leave his seat with forgetting to perform the lock manipulation when, for example, the user hurries, and thus, is the conventional schemes are undesirable from a security viewpoint.

Further, in the conventional schemes as described above, for example, even when the user performed the lock manipulation, the PC having poor performance or the PC installed with many activation programs tends to require a relatively long time until the PC is actually locked after the lock manipulation is performed. Therefore, in the conventional schemes, there is a risk that the PC may be used fraudulently by an unauthorized third party until the PC is locked after the lock manipulation is performed in the conventional scheme.

The disclosed technique intends to enhance the security of an information processing apparatus in consideration of the problems described above.

### SUMMARY

According to an aspect of the present disclosure, there is provided a lock execution method for information processing apparatus, including performing a first authentication based on input information from a user after an application of a power source, preparing authentication information for a second authentication to be corresponded to the input information after the first authentication succeeds, performing the second authentication using the prepared authentication information, issuing a command to execute a lock operation for the information processing apparatus after the second authentication by the authentication succeeds, and invalidating at least some of content of manipulation input during a period time until the lock operation is completed after the command is issued at the issuing.

The object and advantages of the invention will be realized and attained by means of the elements and combinations particularly pointed out in the claims. It is to be understood that both the foregoing general description and the following detailed description are exemplary and explanatory, and are not restrictive of the invention, as claimed.

According to the disclosed technique, the security of the information processing apparatus may be enhanced.

### BRIEF DESCRIPTION OF DRAWINGS

FIG. 1 is a view illustrating an example of a schematic configuration of a lock execution system.

FIG. 2 is a view illustrating an example of a functional configuration of a terminal.

FIG. 3 is a view illustrating an example of a hardware configuration in which a lock execution process may be implemented.

FIG. 4 is a sequence diagram illustrating an example of a first authentication process.

FIG. 5 is a view illustrating an example of credential information.

FIG. 6 is a sequence diagram illustrating an example of a second authentication process.

FIG. 7 is a flowchart illustrating an example of the lock execution process.

FIG. 8 is a view illustrating an example of a monitoring table.

FIG. 9 is a flowchart view illustrating an example of a lock release process.

FIG. 10 is a view illustrating an example of a first screen according to the present embodiment.

FIG. 11 is a view illustrating an example of a second screen according to the present embodiment.

FIG. 12 is a view illustrating an example of a screen in which a monitoring process is performed on the contents of events.

### DESCRIPTION OF EMBODIMENTS

Hereinafter, exemplary embodiments will be described with reference to accompanying drawings in detail.

<Schematic Configuration of Lock Execution System>

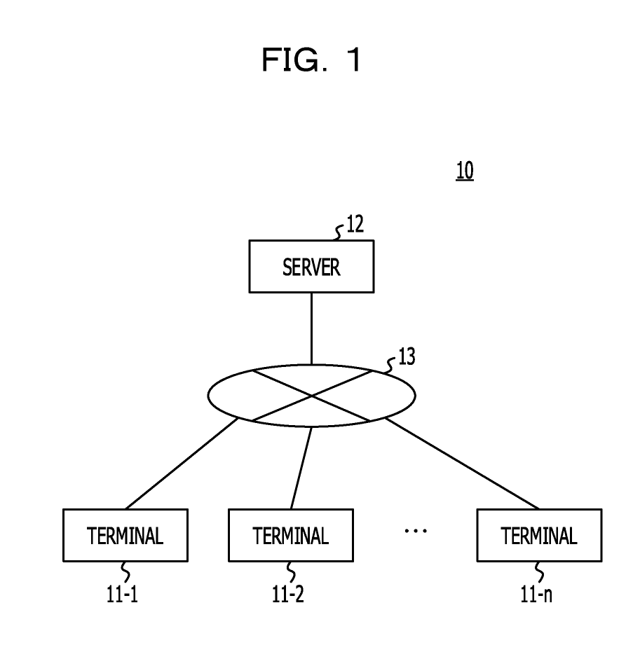

FIG. 1 is a view illustrating an example of a schematic configuration of a lock execution system 10. The lock execution system 10 illustrated in FIG. 1 includes one or plural terminals 11-1˜11-n (hereinafter, collectively referred to as “terminal 11” as needed) used by each user and a server 12. Further, the terminal 11 and the server 12 are connected with each other in a state where data may be transmitted or received therebetween via, for example, a communication network 13 which may be represented by the Internet or a Local Area Network (LAN).

The terminal 11 is an example of an information processing apparatus and is the computer used by the user. The terminal 11 performs, for example, detection of predetermined manipulations, such as a power application by the user, or a user authentication, for example, based on the user identification information (e.g., user ID or password) input from the user after the power application. Further, the power application refers to a turning ON of a power source as well as a reactivation. Further, the terminal 11 performs, for example, a lock execution or a lock release for the terminal 11 based on a result of the authentication.

The user authentication may be performed by collating the input information with authentication information stored in the terminal 11 in advance, or may be performed by the server 12 connected through the communication network 13.

The terminal 11 is provided with, for example, a Basic Input/Output System (BIOS) program, an OS logon program, and an OS service program.

The BIOS program is, for example, a basic program for controlling various hardware within the terminal 11. The BIOS program is recorded on a storage unit such as, for example, a flash memory, and is executed right after the power source of the terminal 11 is turned ON by the user. Further, the BIOS program is allowed to input password (power on password) at the same time when the power source is turned ON and is able to perform authentication by the input password. Further, the BIOS program performs a process of initializing hardware or transferring control to the OS (e.g., Windows) to be activated after a predetermined operation is ended.

The OS logon program is, for example, a program for performing the user authentication for activating a predetermined OS installed on the terminal 11. For example, the OS logon program activates the OS in a case where the user has normally completed an authentication sequence and the authentication is successful. Further, the OS logon program includes, but is not limited to, a Windows logon program.

The OS service program is a program for executing, for example, an OS service. The OS service serves executes, for example, a particular function without performing an interaction with the user. The OS service may be set to be activated during a booting process and may be continuously operated for a long period of time in the background while the OS is running. Further, the OS service may be operated when the user requests the OS service manually.

The OS service described above may include, but is not limited to, a Windows service.

The terminal 11 is associated with, for example, each of the BIOS program, the OS logon program, and the OS service program described above, to perform the processes of a BIOS authentication (first authentication), a OS logon authentication (second authentication) and a lock execution of the terminal 11 consecutively. Accordingly, the terminal 11 is locked right after the activation of the OS to enhance the “security” and thus, the convenience may be enhanced in the present embodiment and the user may leave his seat as soon as possible without manipulating the PC. Therefore, a system may be implemented in the present embodiment where a third party may not use the system fraudulently.

In the present embodiment, the lock execution process (program) for the terminal 11 is operated as the OS service described above and thus, for example, the lock execution process may be activated at an earlier stage than the activation of the built-in program registered in the Windows start-up. Accordingly, the lock execution of the terminal 11 may be made at an earlier timing in the present embodiment. Further, the lock execution process is not limited thereto and, for example, the lock execution process may be registered in the Windows start-up in the present embodiment.

The OS service may, for example, invalidate the manipulations performed for the terminal 11 and monitor the contents of the manipulations performed during a period of time until the lock of the terminal 11 is completed after a lock command of the terminal 11 is issued. That is, in the present embodiment, for example, when the lock execution timing is delayed depending on the performance or the load of the terminal 11, all the contents of the manipulations (e.g., including the contents of events for the terminal 11 corresponding to the contents of the manipulations) during those period of time are blocked (e.g., invalidated). Accordingly, in the present embodiment, for example, it is possible to prevent a third party from referencing or counterfeiting files within the terminal 11 until the lock of the terminal 11 is completed, thereby enhancing the security.

While the terminal 11 is, for example, a general PC, but is not limited thereto, and may be, for example, a notebook type PC or a server. Further, the terminal 11 may be, for example, a portable communication terminal such as a smart phone or a tablet terminal, a game equipment, or a music player. When the portable communication terminal described above is in an unmovable state from a place, such as, for example, during charging, the user may be away leaving behind the portable communication terminal. Accordingly, the portable communication terminal is included in an application range of the terminal 11 which performs the lock execution process.

The server 12 provides various functions such as, for example, the Active Directory (registered trademark) to the respective terminals 11-1˜11-n. The server 12 may construct a domain by the Active Directory described above and thus, manage the user account used when the user logs on or the account of the computer (terminal 11) used by the user under a predetermined network environment.

The server 12 may manage a policy for each user or a group of users. Accordingly, the server 12 may perform, for example, the control of the OS use by the authentication for the terminals 11-1˜11-n connected by, for example, the communication network 13.

The server 12 has a function as, for example, a credential provider. The credential provider has the logon authentication architecture to the OS such as, for example, the Windows, and also serves as a function to install or customize an independent authentication function such as, for example, a fingerprint authentication. Further, the server 12 may manage a shared folder sharing files on the terminal 11 or a printer used for printing by the user through the communication network 13.

While the server 12 may be a Windows server, but is not limited thereto.

In the embodiment as illustrated in FIG. 1 described above, for example, while a logon authentication (e.g., a second authentication) to the OS by the OS password in the terminal 11 is performed using the server 12, the authentication is not limited thereto. For example, when the terminal 11 is not a domain user of the server 12 similar to, for example, a standalone, the logon authentication (e.g., a second authentication) to the OS may be performed in the terminal 11.

<Functional Configuration of Terminal 11>

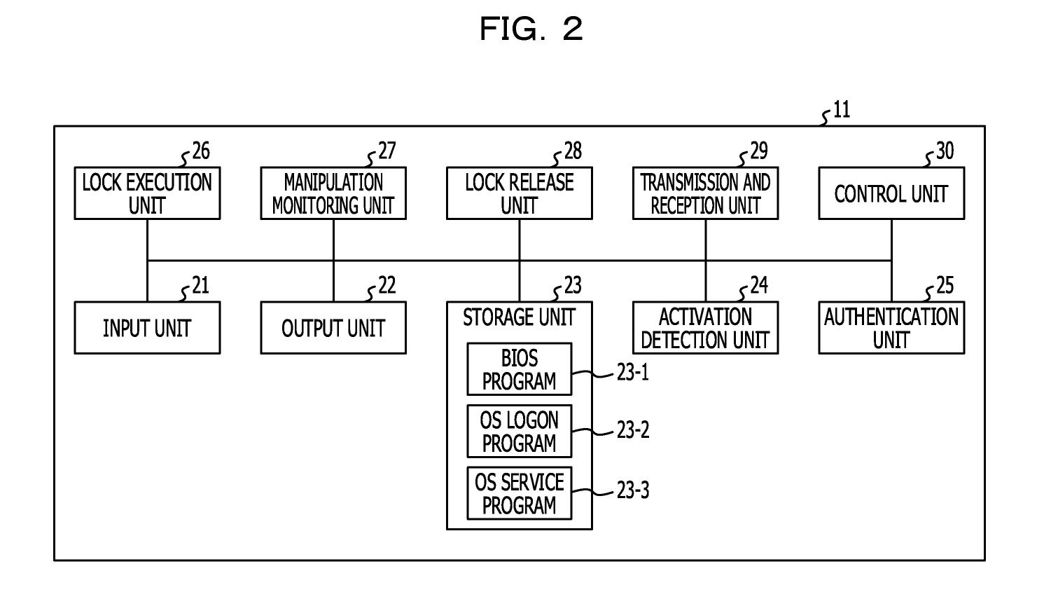

Next, an example of functional configuration of the terminal 11 in the lock execution system 10 described above will be described with reference to the figures. FIG. 2 is a view illustrating an example of a functional configuration of a terminal. The terminal 11 illustrated in FIG. 2 includes an input unit 21, an output unit 22, a storage unit 23, an activation detection unit 24, an authentication unit 25, a lock execution unit 26, a manipulation monitoring unit 27, a lock release unit 28, a transmission and reception unit 29, and a control unit 30.

The input unit 21 receives various inputs such as, for example, start/end of various instructions and inputs for setting from, for example, the user of the terminal 11. Specifically, the input unit 21 receives various instructions such as, for example, an activation detection instruction, an authentication instruction, a notification instruction, a use control instruction, and a transmission and reception instruction in the present embodiment.

An input of information obtained by the input unit 21 may be an input by an input interface such as, for example, a keyboard or a mouse, a touch panel type input using a screen, or an input using, for example, a manipulation key. Further, the input unit 21 may include a voice input unit that inputs voice using, for example, a microphone.

The input unit 21 may include a biometric information acquisition unit for inputting a fingerprint or a vein, for performing, for example, the fingerprint authentication or the vein authentication in the present embodiment. Further, the input unit 21 may include an authentication information acquisition unit for reading the authentication information from information stored in a smart card or a non-contact type IC card such as, for example, Felica (registered trademark), or a security chip in order to perform the authentication in the present embodiment. Further, the input unit 21 may include, for example, a photographing unit such as a camera, which photographs a person who manipulates the terminal 11.

The output unit 22 outputs the content input by the input unit 21 or content executed based on the input content. Further, the output unit 22 may include a display unit such as, for example, a display or a monitor, when the content is output by a screen display, or may include a voice output unit such as, for example, a speaker, when the content is output by voice. Further, the input unit 21 and the output unit 22 may be an input/output integral type unit such as, for example, a touch panel.

The storage unit 23 stores various information needed for the present embodiment. Specifically, the storage unit 23 stores a BIOS program 23-1, an OS logon program 23-2, and an OS service program 23-3 as described above. Further, the storage unit 23 may temporarily store credential information (e.g., logon authentication information to the OS) to be described below, or stores, for example, the authentication information used for authentication in the BIOS program 23-1 or the OS logon program 23-2.

The credential information is created when the authentication by the BIOS password, which is an example of a first authentication, is successful and stored in another area other than a storage area used at previous time. Further, the area other than the storage area used at previous time may be an area randomly set or any one area other than the storage area used at previous time among plural pre-set areas.

The information is stored in different area since when the authentication information such as the credential information is being stored in the same area, the information becomes vulnerable to a stealing. In the present embodiment, security may be further enhanced by storing the credential information in different areas within the storage unit 23 for every activation of the terminal 11. Further, information that indicates the area of the storage unit 23 where the credential information is stored is sent to the OS logon program 23-2, which is an example of the second authentication after, for example, actually storing the credential information.

Further, the storage unit 23 stores a monitoring table used in the OS service program 23-3, a manipulation log obtained with the monitoring process, and a photographed image. Further, the storage unit 23 also stores, for example, various application programs for performing a predetermined function.

Further, the storage unit 23 may read or write various stored information at a predetermined timing as needed. Further, the storage unit 23 is a collection of various kinds of information described above, and may have a function of, for example, a database which is systematically configured such that the information may be retrieved or extracted using, for example, a keyword. Further, the storage unit 23 is constituted by, for example, a hard disk or a memory.

The activation detection unit 24 detects activation of the terminal 11 with, for example, the power application (power ON) by a user. Further, the activation detection unit 24 reads the above-described BIOS program 23-1, the OS logon program 23-2, the OS service program 23-3 for providing the OS service stored in the storage unit 23 in a predetermined sequence to cause the process to be performed in the authentication unit 25 or in the lock execution unit 26.

The authentication unit 25 performs a first authentication process based on the BIOS program 23-1 stored in the storage unit 23 in advance at the time of the power application to the terminal 11. Further, when the user authentication is successful, the authentication unit 25 prepares the credential information and stores the prepared credential information in a predetermined storage area of the storage unit 23. The credential information is newly created, for example, at each time when the terminal 11 is activated (including reactivation), but the creation of the credential information is not limited thereto.

While, the predetermined storage area described above may correspond to an area other than the storage area used at previous time, the predetermined storage area is not limited thereto. Further, from a viewpoint of concealment, the predetermined storage area may correspond to an area where information cannot be written only by, for example, the BIOS program 23-1 and where information cannot be read only by the OS logon program 23-2, but the predetermined storage area is not limited thereto.

Further, the authentication unit 25 may prepare the credential information when the first authentication is successful as well as the first authentication is failed. Accordingly, in the present embodiment, the credential information may be managed as one of log information. Further, the authentication unit 25 may encode and store the prepared credential information. In this case, the authentication unit 25 performs decoding of the credential information read during the second authentication.

The authentication process 25 executes the BIOS program 23-1, and when the user authentication, which is an example of the first authentication, is successful, the authentication process 25 executes the OS logon program 23-2 to perform the logon authentication to the OS which is an example of the second authentication. Specifically, the authentication unit 25 reads, for example, the credential information described above from the storage unit 23 and performs the logon authentication to the OS based on the read credential information. Further, the authentication process 25 executes the OS service program 23-3 to make various OS services (e.g., a lock of the terminal 11) executable.

The authentication unit 25 determines whether the terminal 11 is the domain user of the server 12 in the logon authentication to the OS (second authentication). When the terminal 11 is the domain user of the server 12, the authentication unit 25 requests the server 12 to perform authentication based on the credential information and performs authentication based on a result of the authentication by the server 12. Further, when the terminal 11 is not the user within the domain of the server 12, the authentication unit 25 performs the authentication within the terminal 11 using the credential information. Further, the credential information described above is deleted, for example, in a case where the authentication is successful or the credential information is transferred to the OS.

As described above, the authentication unit 25 is associated with, for example, the BIOS program 23-1 or the OS logon program 23-2 to perform the user authentication (first authentication and second authentication), the type of the first authentication and the second authentication is not limited thereto. That is, the authentication unit 25 in the present embodiment may be an authentication unit that prepares authentication information for the second authentication to be corresponded to the information input at the time of the first authentication after the first authentication is successful, and performs the second authentication using the prepared information.

Further, the authentication unit 25 may output the result authenticated by the authentication unit 25 from the output unit 22. Further, when the authentication is failed, the authentication unit 25 may send a notification for re-inputting, for example, the user identification information using the output unit 22.

When the authentication is successful in the BIOS program 23-1 or the OS logon program 23-2 described above, the lock execution unit 26 performs the lock process of the terminal 11 by the OS service included in the OS service program 23-3 read from the storage unit 23. Specifically, the lock execution unit 26 issues a lock command by the command set in advance to perform the lock process.

The lock process refers to, for example, a process which locks the terminal 11 such that the terminal 11 cannot be manipulated by, for example, a third party, but is not limited to thereto. Further, the lock process may be a lock process for all functions provided in the terminal 11 or some functions set in advance.

The manipulation monitoring unit 27 monitors whether there is any manipulation on the terminal 11 until the lock is completed after the lock command is executed by the lock execution unit 26. For example, the manipulation monitoring unit 27 executes an event hook to monitor manipulation on the terminal 11. The event hook obtains, for example, input information (hereinafter, referred to as “event”) corresponding to the manipulation content by the input unit 21, such as, for example, a mouse or a keyboard, provided in the terminal 11, monitors which event is generated, or invalidates the manipulation.

That is, the manipulation monitoring unit 27 executes the event hook to invalidate, for example, all events input by, for example, the input unit 21 or events other than an event set in advance. Further, the event set in advance refers to, for example, an event that is irrelevant to a direct manipulation for an unauthorized use (e.g., manipulation for copy or deletion of file). Examples of the events set in advance include movement of cursor on the screen by the mouse or manipulation of turning the power source OFF or manipulation for releasing the lock by inputting, for example, the password or the fingerprint information, but the event set in advance is not limited thereto.

Further, the manipulation monitoring unit 27 performs a monitoring process set in advance correspondingly to the input event content. The monitoring process set in advance includes, but not limited thereto, recording the event content into log, ringing a warning sound, photographing the manipulator with a camera provided in the terminal or an external camera, or making the screen invisible.

The lock release unit 28 receives a predetermined manipulation input to release the lock of the terminal 11 by, for example, the user. When the received input information satisfies a condition for lock release, the lock release unit 28 releases the lock of the terminal 11. As the condition for lock release, for example, the authentication such as the first authentication or the second authentication may be performed for the lock release and the authentication for lock release may be performed using other authentication sequence. Further, when the lock release by the lock release unit 28 is ended normally, monitoring by the manipulation monitoring unit 27 is ended.

The transmission and reception unit 29 is, for example, a communication unit for transmitting to and receiving data from an external device such as the server 12 through the communication network 13. The transmission and reception unit 29 is able to receive various information stored in advance in, for example, the external device and transmit the result processed in the terminal 11 to, for example, the external device through the communication network 13.

The control unit 30 controls the entirety of the respective components of the terminal 11. Specifically, the control unit 30 performs the respective controls regarding control of use based on, for example, the instruction from the input unit 21 by the user. Here, the respective controls includes, but is not limited to, detection of activation in the activation detection unit 24, authentication by the authentication unit 25, lock execution by the lock execution unit 26, manipulation monitoring by the manipulation monitoring unit 27, and a lock release by the lock release unit 28. Further, these controls may be performed based on input of a predetermined event by, for example, the instruction of the user or the execution of a program, or may be performed at predetermined time intervals regularly.

<Hardware Configuration of Terminal 11>

The terminal 11 described above generates an execution program (e.g., a lock execution program) which is able to cause the computer to execute the respective functions to install the execution program on, for example, a general PC and thus, the lock execution process in the present embodiment may be implemented. Here, an example of a hardware configuration of a computer in which the lock execution process in the present embodiment may be implemented will be described with reference to figures.

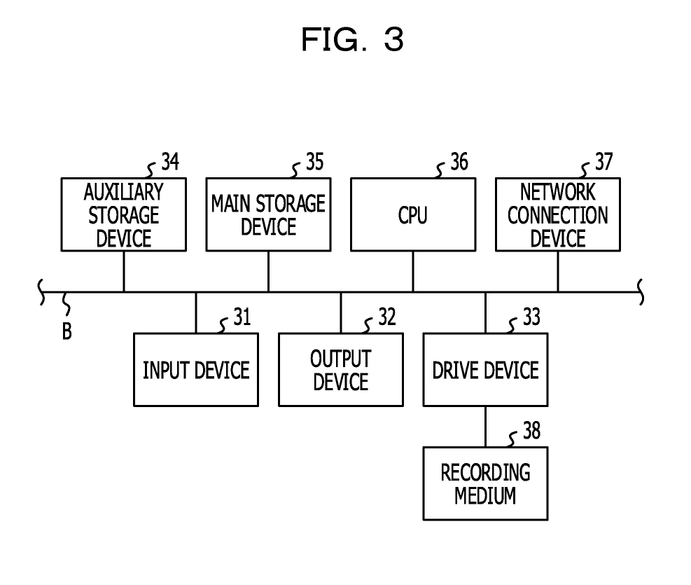

FIG. 3 is a view illustrating an example of a hardware configuration in which a lock execution process may be implemented. The main body of the computer in FIG. 3 is configured to include an input device 31, an output device 32, a drive device 33, an auxiliary storage device 34, a main storage device 35, a central processing unit (CPU) 36 which performs various controls and a network connection device 37, and these devices are connected with one another via a system bus B.

The input device 31 includes a pointing device such as a keyboard or a mouse manipulated by the user or a voice input device such as a microphone. The input device 31 inputs, for example, a program execution instruction from the user, various manipulation information, and information for activating software.

The output device 32 includes a display which displays, for example, various windows or data needed for manipulating the main body of the computer used for performing the processes in the present embodiment. The output device 32 may display an execution result or passage of a program by the control program provided in the CPU 36. Further, the output device 32 may print, for example, the process result described above on a paper to present the result to the user.

Here, the execution program installed in the main body of the computer in the present embodiment is provided by, for example, a Universal Serial Bus (USB) memory, or a portable recording medium 38 such as a CD-ROM or a DVD. The recording medium 38 having the program recorded therein may be set in the drive device 33, and the execution program included in the recording medium 38 is installed in the auxiliary storage device 34 from the recording medium 38 through the drive device 33 based on the control signal from the CPU 36.

The auxiliary storage device 34 is a storage unit such as the hard disk, and may store the execution program in the present embodiment or the control program installed in the computer to input/output the programs as needed based on the control signal from the CPU 36. Further, the auxiliary storage device 34 stores the BIOS program 23-1, the OS logon program 23-2, or the OS service program 23-3. Further, the auxiliary storage device 34 stores, for example, the user identification information input by the user and identification information which permits authentication for collation.

The auxiliary storage device 34 may read necessary information from the stored respective information, or necessary information may be written into the auxiliary storage device 34, based on the control signal from the CPU 36.

The main storage device 35 stores the execution program read from the auxiliary storage device 34 by the CPU 36. Further, the main storage device 35 is constituted by, for example, a Read Only Memory (ROM) or a Random Access Memory (RAM). Further, the main storage device 35 stores the credential information described above. Further, the auxiliary storage device 34 and the main storage device 35 correspond to, for example, the storage unit 23 described above.

The CPU 36 may implement the respective processes such as various operations or data input/output with each hardware component by controlling the entire processes of the computer based on the control program of, for example, the operating system and the execution program stored in the main storage device 35. Further, various information needed for execution of the program may be acquired from the auxiliary storage device 34 and the execution result may be stored in the auxiliary storage device 34.

Specifically, the CPU 36 executes the lock execution program installed in the auxiliary storage device 34 based on, for example, the execution instruction of the program from the CPU 36 obtained from the input device 31 to perform a process corresponding to the program on the main storage device 35. For example, the CPU 36 executes the lock execution program to perform the process of the detection of activation by the activation detection unit 24, the authentication by the authentication unit 25 or the lock execution by the lock execution unit 26, as described above. Further, the CPU 36 executes the lock execution program to perform the process of the manipulation monitoring by the manipulation monitoring unit 27 or the lock release of the lock release unit 28, as described above.

Further, the contents of the processes in the CPU 36 are not limited to what have been described above. The contents executed by the CPU 36 may be stored in the auxiliary storage device 34 as needed.

The network connection device 37 is connected with, for example, the communication network 13 to obtain an execution program, software, or set information from an external device connected to the communication network 13 based on the control signal from the CPU 36. Further, the network connection device 37 may provide the external device with the execution result obtained by executing the program or the execution program itself in the present embodiment.

According to the hardware configuration described above, the lock execution process may be executed in the present embodiment. Further, the program is installed such that the lock execution process in the present embodiment may be readily implemented with, for example, a general PC.

<Lock Execution Process in the Terminal 11>

Next, an example of the lock execution process in the terminal 11 will be described using a flowchart. Examples of the lock execution process in the present embodiment include a first authentication process in the BIOS program 23-1, a second authentication process in the OS logon program 23-2, and a lock execution process in the OS service. Therefore, the respective processes described above will be described in detail in the following description.

<First Authentication Process (BIOS Program 23-1)>

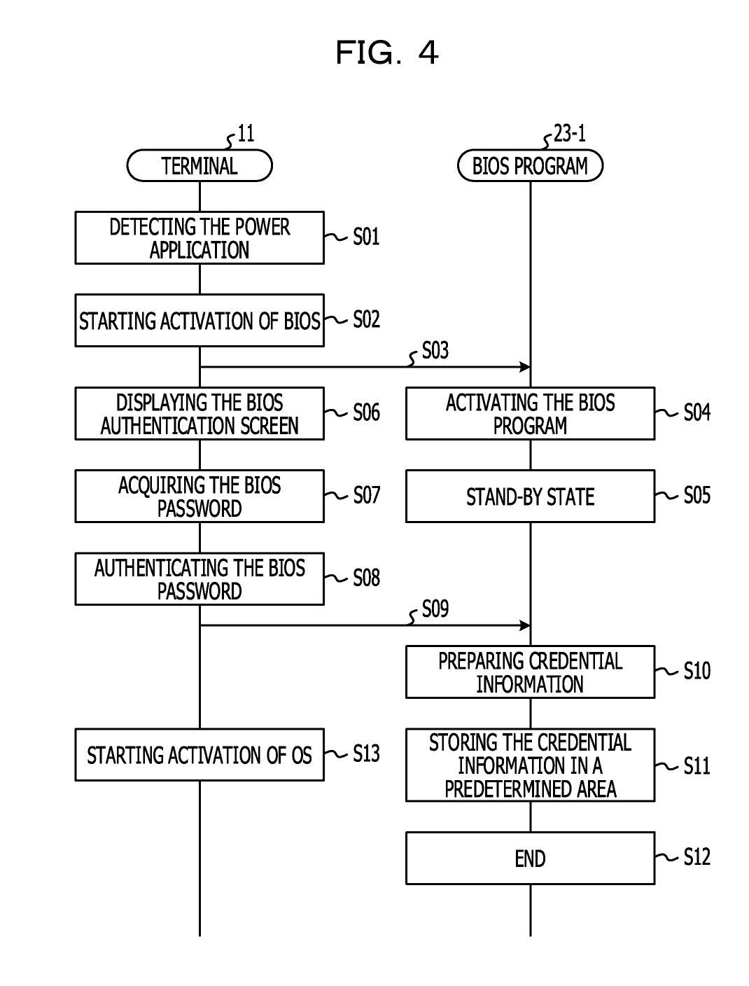

FIG. 4 is a sequence diagram illustrating an example of a first authentication process. Further, in the example of FIG. 4, a process of the terminal 11 (process other than a process of the BIOS program 23-1) and the process of the BIOS program 23-1 are explained separately in order to explain the operations of the process in the BIOS program 23-1.

In the first authentication illustrated in the example of FIG. 4, when the power application to the terminal 11 by the user is detected (S01), the terminal 11 starts activation of the BIOS stored in the storage unit 23 (S02). The BIOS program 23-1 receives an instruction to initiate activation of the BIOS (S03) and reads and activates the BIOS program 23-1 stored in the storage unit 23 (S04). Further, the BIOS program 23-1 remains in a stand-by state until the user enters the BIOS password which is an example of the authentication information (S05).

The terminal 11 starts the activation of the BIOS by the process of the step S02 described above and then, displays an authentication screen of the BIOS on, for example, the output unit 22 asynchronously with the operation of the BIOS program 23-1 to present the authentication screen of the BIOS to the user (S06). Here, the user may enter the BIOS password in an area prepared in, for example, the authentication screen of the BIOS by the process of the step S06 using, for example, the input unit 21.

The terminal 11 acquires the BIOS password as an example of the input information input by the user (S07) and performs a BIOS password authentication (first authentication) based on the acquired BIOS password authentication (first authentication) (S08).

When the authentication is successful (authentication result is “OK”), the terminal 11 outputs the authentication result to the BIOS program 23-1 (S09). Further, when the authentication is failed (authentication result is “NG) in the process of step S08, the terminal 11 displays a message screen indicating, for example, an authentication error on the output unit 22 and then, may cause the user to re-input or may turn the power source OFF. Further, even when the authentication is failed in the process of step S08, the terminal 11 may output the authentication result to the BIOS program 23-1 to cause the BIOS program 23-1 to prepare the credential information.

When information that the authentication is successful is received by the process of step S09, the BIOS program 23-1 releases the stand-by state and prepares credential information including authentication information with respect to the logon authentication to the OS (second authentication) (S10). Further, the BIOS program 23-1 stores the prepared credential information in a predetermined area in the storage unit 23 (S11), and ends the BIOS program 23-1 (S12).

Further, the predetermined area may be an area other than the storage area used at previous time among areas prepared within the storage unit 23 in the process of step S12 as described above, but is not limited thereto.

When the authentication of the BIOS password is successful, the terminal 11 starts activation of the OS (e.g., Windows) (S13).

<Specific Example of Credential Information>

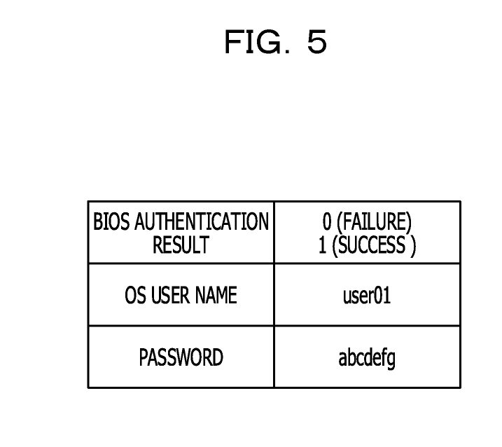

A specific example of the credential information described above will be described with reference to figures. FIG. 5 is a view illustrating an example of the credential information. The credential information illustrated in the example of FIG. 5 includes, for example, “BIOS authentication result”, “OS user name” and “password” as items, but a type or an order of the item and a data type are not limited thereto. For example, the credential information may include time information when information described above is prepared or information such as time (time limit) during which the information may be used.

The “BIOS authentication result” stores, for example, a result of the BIOS authentication in the BIOS program 23-1 described above. For example, in the example of FIG. 5, when the authentication is successful, “1” is stored and when the authentication is failed, “0” is stored, but is not limited thereto, and when the authentication is successful, “OK” or “∘” may be stored, and when the authentication is failed, “NG” or “x” may be stored.

When the BIOS authentication is executed, for example, the “OS user name” stores the OS user name that corresponds to input information. For example, “user01” is stored as the “OS user name” in the example of FIG. 5.

When the BIOS authentication is executed, the “password” stores the password that corresponds to input information. For example, “abcdefg” is stored as the “password” in the example of FIG. 5.

The “OS user name” or the “password” may be prepared by, for example, being corresponded to input information (BIOS password) input to the BIOS program 23-1, or may be prepared by reading the authentication information stored in, for example, the storage unit 23. Specifically, in a case of the “OS user name”, the same user name as the input information or a user name set in advance with being corresponded to, for example, the BIOS password may be used. Further, in a case of the “password”, for example, the same password as the BIOS password may be used, or another password generated by altering the BIOS password according to a predetermined condition or a one-time password may be used. That is, for the “password”, for example, a Personal Identification Number (PIN) or an authentication code used at the time of authentication is used. Further, when biometric information such as the fingerprint or vein is used in the first authentication, the user name or password which is set in advance to be corresponded to the biometric information may be used.

Here, the credential information as described above may be stored in a separate area (e.g., another area other than the storage area used at least at the previous) in the storage unit 23, such as, for example, a memory for each time. In the present embodiment, the credential information is stored in the separate area each time when the credential information is prepared and thus, the same information is not allowed to be repeatedly used and unauthorized referencing or counterfeiting by a third party may be prevented.

<Second Authentication Process (OS Logon Program 23-2)>

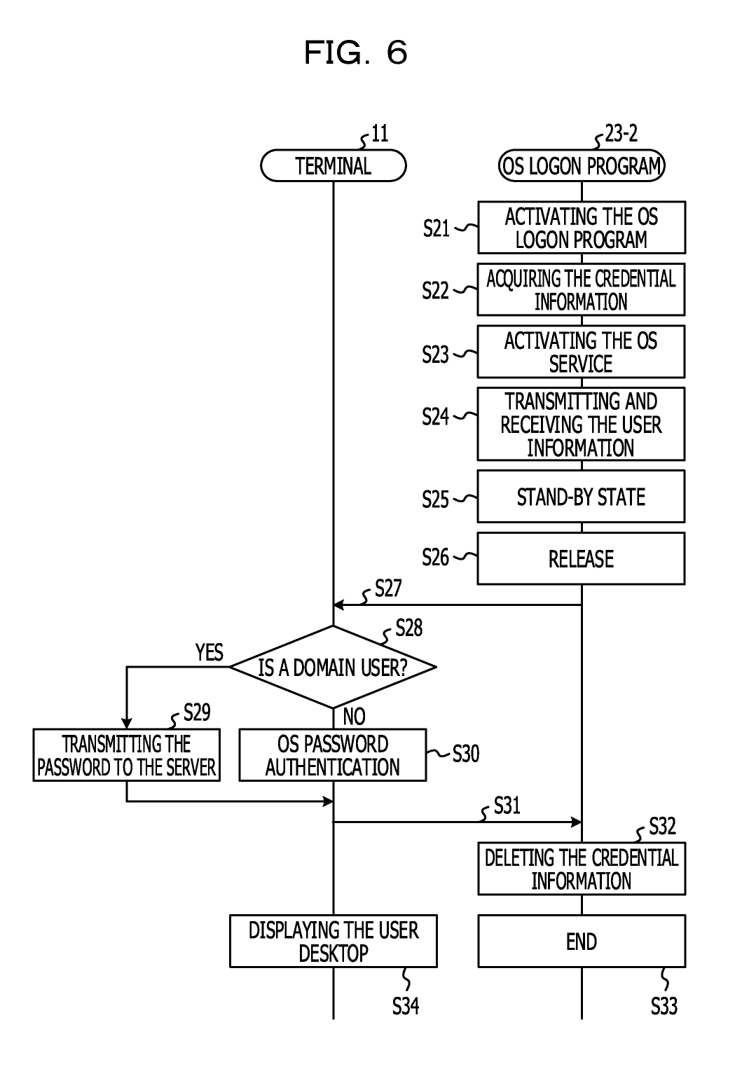

FIG. 6 is a sequence diagram illustrating an example of a second authentication process. Further, in the example of FIG. 6, a process of the terminal 11 (process other than a process of the OS logon program 23-2) and the process of the OS logon program 23-2 will be explained separately in order to explain operations of the process in the OS logon program 23-2.

In the second authentication process illustrated in FIG. 6, when activation of the OS (e.g., the Windows) starts at the terminal 11 side by the process of step S14 described above, the OS logon program is activated in the OS logon program 23-2 according to the activation (S21). Further, the OS logon program 23-2 acquires the credential information prepared by the BIOS program 23-1 (S22).

Subsequently, the OS logon program 23-2 activates the OS service by, for example, the OS service program 23-3 (S23). Further, the OS logon program 23-2 extracts the user information needed for execution of the OS service by the OS service program 23-3 from the credential information and transfers the extracted user information to the OS service (S24).

The OS logon program 23-2 goes into a standby state until the OS service by the OS service program 23-3 is activated after the extracted user information is transferred by the process of step S24 (S25).

The OS logon program 23-2 then detects activation of the OS service program 23-3 to release the standby state (S26). Further, since the lock execution process by the OS service program 23-3 is ready to be executed later on with detecting the activation of the OS service program 23-3, the OS logon program 23-2 may determine that the OS logon process may be allowed to be executed. The OS logon program 23-2 sends information, such as the password, included in the credential information to the terminal 11 (S27).

The terminal 11 executes the OS password authentication (e.g., second authentication) using information, such as the password obtained from the OS logon program 23-2. Further, PIN or the authentication code may be input as the OS password to logon a desired OS (e.g., the Windows), but the type of password is not limited thereto.

The terminal 11 may be connected in a predetermined network managed by, for example, the server 12 as illustrated in FIG. 1 in the present embodiment. Accordingly, it is determined whether the terminal 11 is a domain user in the present embodiment (S28). When it is determined that the terminal 11 is the domain user (determination result is “YES” at step S28), the terminal 11 transmits password to the server (Active Directory) 12 (S29) and causes the server to perform the OS password authentication. Further, when it is determined that the terminal 11 is not the domain user (determination result is “NO” at step S28), the OS password authentication is performed in the terminal 11 (S30).

When the authentication result is successful in the process of step S29 or S30, the terminal 11 transmits information that the authentication result is successful to the OS logon program 23-2 (S31). Further, in the process of step S31, the terminal 11 may transmits instruction to delete the credential information in the process of step S31.

The OS logon program 23-2 receives information that the authentication result is successful or instruction to delete the credential information from the terminal 11 by the process of step S31 to delete the credential information (S32), and ends the OS logon the program (S33). Further, since the authentication to the OS is successful, the terminal 11 displays the user desktop (e.g., manipulation screen) on the output unit 22 (S34).

When authentication succeeds in the second authentication process described above, the OS logon program 23-2 may end the process of the OS logon program 23-2 after notifying a successful authentication to the OS service.

That is, in the present embodiment, the user is not required to input after waiting until the OS (e.g., the Windows) is activated and may leave his seat right after inputting the BIOS password for the first authentication by the process described above. Accordingly, security is further ensured.

<Lock Execution Process (OS Service Program 23-3)>

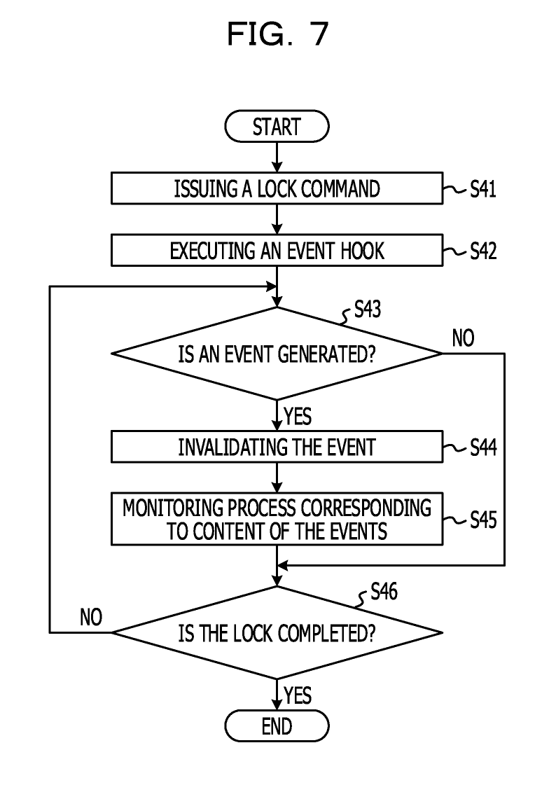

FIG. 7 is a flowchart illustrating an example of a lock execution process. An example of the OS service illustrated below may include, but is not limited to, the Windows service.

In the lock execution process of FIG. 7, for example, when the password authentication process to the OS indicated in the process of step S29 or S30 is completed or the process to delete the credential information in the process of step S32 is completed, the OS service issues a lock command of the terminal 11 (S41).

The OS service in the present embodiment is operated as a service activated by the OS logon program 23-3 and thus, it becomes possible to be activated at an earlier stage than the built-in program registered in the start-up in order to automatically execute upon activation of the OS.

The OS service program 23-3 in the lock execution process executes an event hook (S42). As described above, event hook is a procedure that is able to obtain a message of the event to allow the OS service to monitor which event is generated or invalidate the manipulation for the event.

The OS service program 23-3 determines whether the event is generated (S43). In the present embodiment, when no one performs any manipulation with respect to the terminal 11, an event is not generated. In contrast, an event is generated when someone performs the mouse manipulation or the keyboard manipulation with respect to the terminal 11.

When it is determined that an event is generated (determination result is “YES” at step S43), the OS service program 23-3 invalidates the generated event (S44). Further, in an invalidation process, for example, when a third party (e.g., a person who manipulates) clicks a left button of the mouse which is the input unit 21 of the terminal 11, a click event is generated, but the event is notified to the OS by being replaced by, for example, a separate event value. Accordingly, in the present embodiment, it can be regarded as if a click action itself of the left button of the mouse does not occur. As described above, in the present embodiment, an unauthorized use by the third party may be reliably prevented by invalidating the event and thus, even though a lock execution timing of the terminal 11 is delayed due to some reason, security may be maintained.

The OS service program 23-3 performs the monitoring process corresponding to content of the events as needed after performing the process indicated at the step S44 described above (S45). Further, a specific example of the monitoring process that corresponds to content of the event will be described later.

When an event is not generated in the process of step S43 (determination result is “NO” at step S43) described above or after the process of step S45 ends (S46), the OS service program 23-3 determines whether the lock of the terminal 11 is completed. When the lock is not completed (determination result is “NO at step S46), the OS service program 23-3 goes back to the process of step S43. Further, when the lock is completed (determination result is “YES” at step S46), the OS service program 23-3 ends the process in the OS service program 23-3.

That is, invalidation of event and monitoring the content of event are performed until the event hook is executed and the lock of the terminal 11 is completed after the lock command is issued in the example of FIG. 7.

<Monitoring Process for Event Content>

An example of the monitoring process for the event content described above will be described herein. The invalidation of the event content and an additional monitoring process for the event content may be performed as processes in the OS service program 23-3 (manipulation monitoring unit 27) in the present embodiment.

Specifically, the monitoring table may be stored in the storage unit 23 in advance in the present embodiment. When any manipulation is performed on the terminal 11 during a period of time until the lock of the terminal 11 is completed after the lock command is executed, the OS service program 23-3 invalidates the event content manipulated. Further, the OS service program 23-3 references the monitoring table stored in the storage unit 23 to perform the monitoring process corresponding to the content of event.

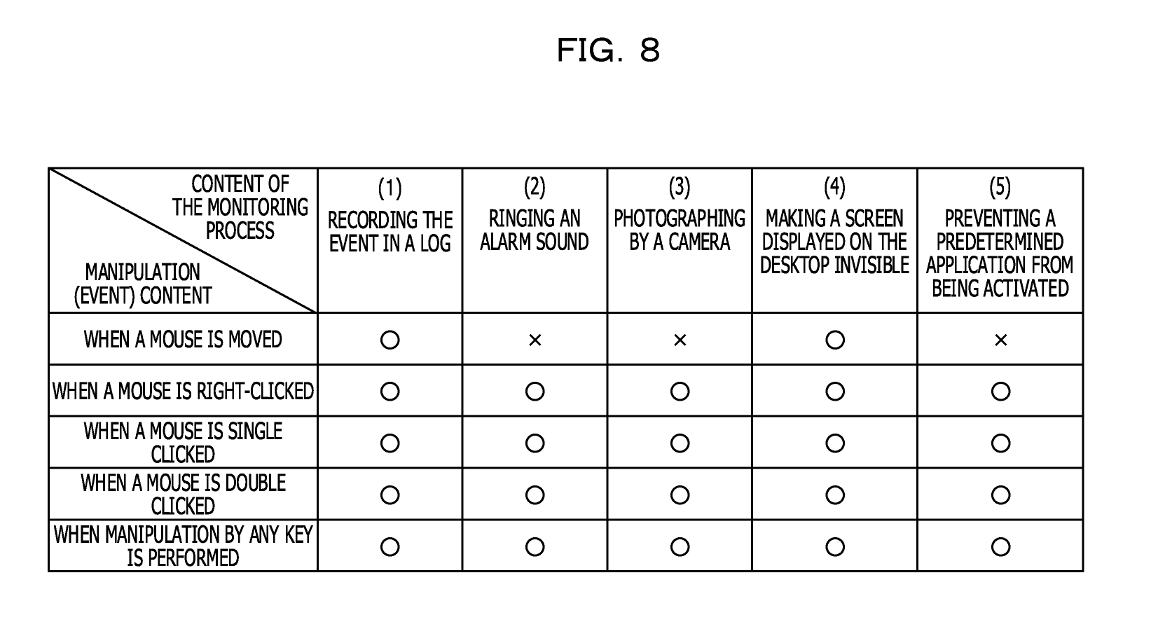

FIG. 8 is a view illustrating an example of a monitoring table. In the monitoring table of FIG. 8, specific content of the monitoring process with respect to the manipulation by someone set in advance are indicated and whether the monitoring process is to be performed for each manipulation is set. Examples of the manipulation (event) contents illustrated in FIG. 8 include, but is not limited to, “when a mouse is moved”, “when a mouse is right-clicked”, “when a mouse is single clicked”, “when a mouse is double clicked”, “when manipulation by any key of a keyboard is performed”. Further, the contents of the monitoring process illustrated in FIG. 8 include, but is not limited to, “(1) recording the event in a log file”, “(2) ringing an alarm sound”, “(3) photographing by a camera”, “(4) making a screen displayed on the desktop invisible”, and “(5) preventing a predetermined application (hereinafter, referred to as “app”) from being activated”.

For example, “(1) recording the event in a log file” is executed to record the generated event, such as manipulation time or manipulation content, as a manipulation log record, thereby enabling the recording to be used as a clue of locating an unauthorized user in the present embodiment. Further, “(2) ringing an alarm sound” is executed to sound a big alarm to cope with a suspicious manipulation, thereby making it possible to let the people know quickly that there is a suspicious individual in the present embodiment.

Further, “(3) photographing by a camera” is executed to photograph a suspicious manipulation by a photographing unit such as a camera installed in the terminal 11, thereby enabling the photographing to be used as a clue of locating an unauthorized user in the present embodiment. Further, “(4) making a screen displayed on the desktop invisible” is executed, thereby making it possible to prevent a screen from being referenced to a third party in consideration of likelihood that the screen is displayed on the desktop in the present embodiment.

Further, “(5) preventing activation of a predetermined application from being activated” is executed to prevent the specific app from being activated, thereby allowing a limited use control to be performed in the present embodiment.

That is, at least one contents of the monitoring process is set in coping with one manipulation to the terminal 11 until the lock is completed after the lock command is issued as illustrated in FIG. 8 in the present embodiment. In the example of the monitoring table illustrated in FIG. 8, “∘” is set for the monitoring process executed with respect to some manipulation and “x” is set for the monitoring process not executed with respect to some manipulation.

For example, event is recorded in the log file and the screen displayed on the desktop is made invisible in a case where a mouse which is an example of the input unit 21 is moved by someone during a period of time until the lock is completed after the lock command is issued in the present embodiment. Further, when there are plural monitoring process contents, the monitoring processes may be performed in a numbered order of (1), (2), (3), (4) and (5) illustrated in FIG. 8, but the performance order of the processes may be changed according to, for example, the event content.

<Lock Release Process>

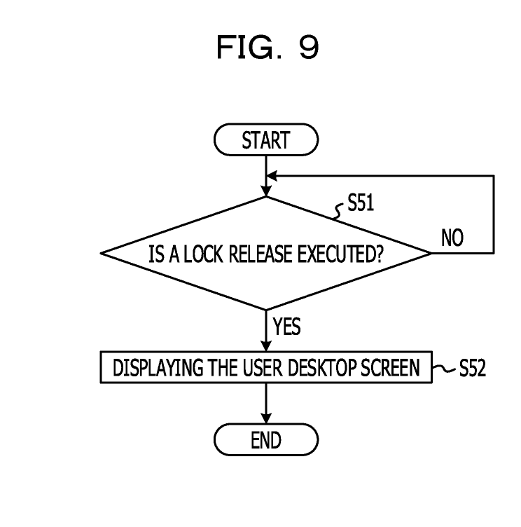

Here, the terminal 11 which is locked is used by an authorized user and thus, a lock release of the lock of the terminal 11 described above is required in the present embodiment. Therefore, a lock release process in the present embodiment will be described in detail. FIG. 9 is a flowchart illustrating an example of the lock release process. Further, it is assumed that the user is left behind his seat at present time and the terminal 11 located in his seat is in a locked state.

The terminal 11 determines whether a lock release is executed (S51). When it is determined that the lock release is not executed (determination result is “NO” at step S51), the lock release process remains in a locked state until the lock release is executed.

When the user comes back to his seat, receives, for example, execution of a predetermined event corresponding to the lock release of the terminal 11 and the lock release is executed (determination result is “YES” at step S51), the terminal 11 displays the user desktop (e.g., the manipulation screen) to be presented to the user (S52). Accordingly, the user may perform various manipulations with respect the terminal 11 and thus, the user is able to start, for example, a work.

<Screen Example>

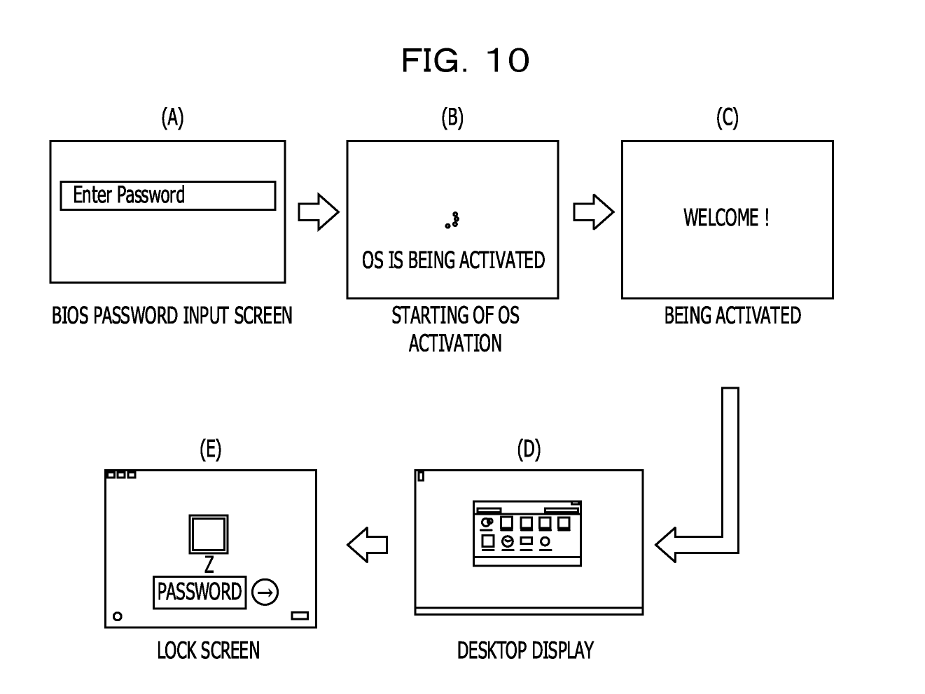

Here, the screen example in the present embodiment will be described with reference to figures. FIG. 10 is a view illustrating an example of a first screen in the present embodiment. In the first screen example, a power source of the terminal 11 is turned ON, the screens are displayed in order of FIG. 10A, FIG. 10B, FIG. 10C, FIG. 10D and FIG. 10E illustrated below.

When the power source of the terminal 11 is turned ON by the user in the present embodiment, information of the turning ON of the terminal 11 is detected to cause an input screen of the BIOS password illustrated in FIG. 10A to be displayed. Further, in the example of FIG. 10A, an input area for characters and password, for example, “Enter Password:” is displayed on the screen of the terminal 11, but the input screen is not limited thereto.

Next, when the user inputs the BIOS password and authentication succeeds, the screen which displays that activation of the OS (e.g., the Windows) is initiated as illustrated in FIG. 10B is displayed in the present embodiment.

In this case, the credential information described above is prepared by the BIOS program 23-1 and is stored in, for example, the storage unit 23 in the present embodiment. Further, the credential information described about is read from, for example, the storage unit 23 by the OS logon program 23-2 and an authentication to the OS is performed using the read credential information in the present embodiment. Further, when the terminal 11 is connected to, for example, the network 13 and a network environment is managed by the server 12, the terminal 11 transmits, for example, the credential information to request to authenticate. Further, when the terminal 11 is, for example, a standalone terminal, the terminal 11 performs the authentication to the OS using, for example, authentication information self-managed by the terminal 11.

When the authentication to the OS is successful, a message, for example, “Welcome!” is displayed on the screen to activate the built-in program such as the OS as illustrated in FIG. 10C and the desktop screen is displayed as illustrated in FIG. 10D. In this case, the OS service program 23-3 is already activated and the lock command is being executed by the OS service and thus, the lock of the terminal 11 is completed immediately and a lock screen is displayed as illustrated in FIG. 10E in the present embodiment.

Further, the screen in which the password is to be input is displayed in order to release the lock in the lock screen illustrated in FIG. 10E, but the screen for the lock release is not limited thereto. For example, a screen saver may be displayed, or a message screen such as “Your computer is being locked” may be displayed.

An authentication scheme using password is described in the example described above, but the authentication scheme is not limited thereto, and, the authentication scheme may be implemented using, for example, the finger print information.

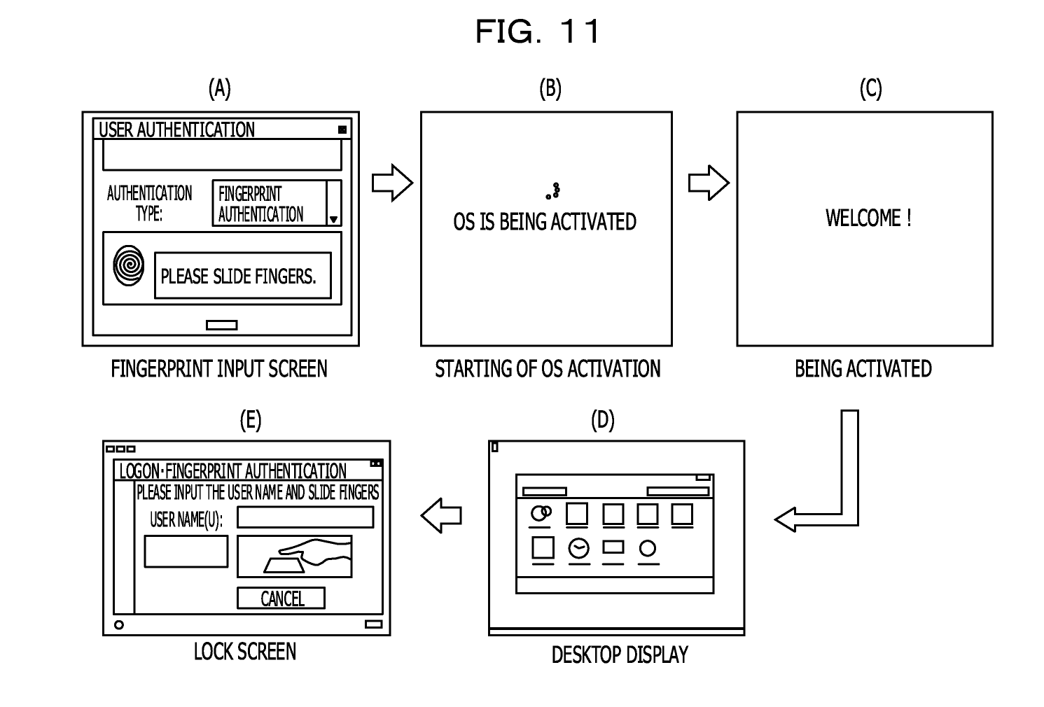

FIG. 11 is a view illustrating an example of a second screen in the present embodiment. In the second screen example, a power source of the terminal 11 is turned ON, the screen is displayed in an order of FIG. 11A, FIG. 11B, FIG. 11C, FIG. 11D and FIG. 11E illustrated below. Further, when the second screen example is compared with the first screen example described above, the screens of FIGS. 11B, 11C and 11D are the same as those of FIGS. 10B, 10C and 10D described above and thus, detailed description of screens of FIGS. 11B, 11C and 11D will be omitted here.

In the second screen example, the fingerprint input screen is displayed at first as illustrated in FIG. 11A. When the user inputs the fingerprint by, for example, a biometric information acquisition unit prepared as the input unit 21, collates the inputted fingerprint with the fingerprint information registered in advance and the authentication succeeds, the activation of the OS starts as illustrated in FIG. 11E. In this case, the credential information described above is prepared and stored in, for example, the storage unit 23 in the present embodiment. Further, the credential information described above is used during the OS authentication.

When the OS authentication succeeds, the OS is actually activated as illustrated in FIG. 11C and the desktop screen is displayed as illustrated in FIG. 11D, and a screen for the lock of the terminal 11 is displayed as illustrated in FIG. 11E right after the desktop screen is displayed. Further, in the lock screen illustrated in FIG. 11E, the screen in which the fingerprint is requested to be input again is displayed in order to release the lock, but a screen for the lock release is not limited thereto. For example, a screen saver may be displayed, or a message screen such as “Your computer is being locked” may be displayed.

An authentication by the fingerprint authentication described above as well as the vein authentication may be performed as the biometric authentication in the present embodiment. The vein authentication may be performed in such a manner that palm of the user is read according to instruction from the terminal 11 to allow the biometric information acquisition unit to acquire the vein and collate the acquired vein with the registered authentication in advance.

The above-described password authentication, the fingerprint authentication, and the vein authentication may be performed in combination of a plurality of the authentications. Also, other authentications may be used using various authentication schemes such as, for example, a shape of palm, retina, iris, blood vessel, sound (voice print), a shape of ear, and handwriting, but the authentication scheme is not limited thereto.

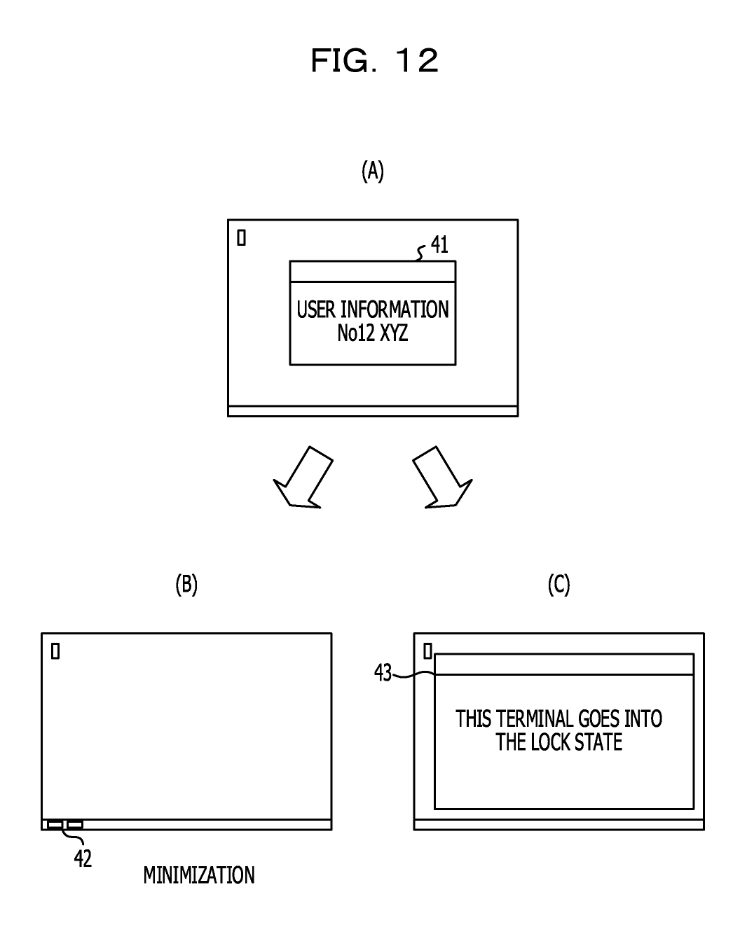

FIG. 12 is a view illustrating an example of a screen in which a monitoring process is done on the content of events. Further, FIG. 12A illustrates an example of conventional screen, and FIG. 12B and FIG. 12C describe the screen examples in order to make the screens displayed on the desktop invisible, as examples of the monitoring process.

For example, the window screen 41 in which the confidential information, such as “The user information No12 XYZ”, is displayed remains with being displayed on the screen during a period of time until the lock of the terminal 11 is completed in the conventional screen as illustrated in FIG. 12A. Therefore, when a third party performs any event manipulation, the content of the window screen 41 becomes easy to be read in the conventional screen example.

Therefore, in the present embodiment, the window screen 41 being displayed is minimized and thus, it is possible to prevent third parties from reading the content easily as illustrated in FIG. 12B. Further, the window screen 41 may be minimized by being moved to, for example, the taskbar 42 on the screen, but the contents reading prevention scheme is not limited thereto in the example of FIG. 12B.

Further, in the present embodiment, the window screen 4 is displayed on a front-end surface to conceal the entirety of the screen using, for example, the dummy screen 43 set in advance as illustrated in FIG. 12C. Accordingly, the screen displayed behind the dummy screen 43 may be prevented from being read in the present embodiment.

Further, a predetermined text characters such as, for example, “This terminal is transferred to a lock state from now” may be displayed in the dummy screen 43. As described above, in the present embodiment, it is possible to make it difficult for the third party to use without an authorization by displaying the text characters described above.

<OS in the Present Embodiment>

The Windows is described as an example of the OS in the present embodiment described above, but the OS is not limited thereto. For example, any OS may be applied in the present embodiment as long as the OS has a function of the BIOS described above, a function (e.g., Credential Provider) that controls, for example, logon to the OS or the lock.

Accordingly, for example, any one of Linux (registered trademark) or Unix (registered trademark), Android (registered trademark), and Mac (registered trademark) as an example of the OS other than the Windows, may be applied in the present embodiment.

According to the embodiment described above, security may be enhanced. Specifically, in the present embodiment, the first authentication, the second authentication and the lock execution process are associated with one another to lock the terminal 11 right after the OS is activated to enhance security. Further, the user does not need to manipulate as soon as possible and thus, the convenience may be enhanced.

Further, the execution of the lock is executed as the OS service in the present embodiment and thus, the execution of the lock may be executed rapidly as compared to a case where the execution of the lock is registered as the start-up program. Further, in the present embodiment, the terminal may be locked right after activation and thus, the user does not need to wait until the OS is operated.

Further, in the present embodiment, the event such as, for example, a keyboard input or a mouse manipulation may be invalidated during a period of time until the lock is completed after the lock command of the terminal is issued and thus, for example, an unauthorized use by a third party user may be prevented. Further, the manipulation log is stored or photographing by the camera is performed by being corresponded to the event performed during a period of time until the terminal is locked and thus, it is possible to trace an individual who attempts an unauthorized use in the present embodiment, thereby enabling to identify a criminal rapidly.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has (have) been described in detail, it should be understood that the various changes, substitutions, and alterations could be made hereto without departing from the spirit and scope of the invention.

What is claimed is:

1. An information processing apparatus, comprising:
a processor configured to
perform a first authentication based on input information from a user after an application of a power source, prepare authentication information for a second authentication to be corresponded to the input information after the first authentication succeeds, and perform the second authentication using the prepared authentication information; and
issue a command to execute a lock operation for the information processing apparatus after the second authentication and invalidate at least some of contents of manipulation input during a period of time until the lock operation is completed after the command is issued.

2. The information processing apparatus according to claim 1, wherein the processor is configured to execute a single process or plural processes corresponded to the input content of manipulation.

3. The information processing apparatus according to claim 1, wherein the processor deletes the authentication information after the second authentication succeeds.

4. The information processing apparatus according to claim 1, further comprising a storage device configured to store the authentication information for the second authentication, wherein when the authentication information is stored in the storage device, the processor stores the authentication information in an area other than a storage area used at previous time.

5. The information processing apparatus according to claim 1, wherein the first authentication is an authentication that uses a BIOS password or biometric information of the user.

6. The information processing apparatus according to claim 1, wherein the second authentication is logon authentication to OS.

7. The information processing apparatus according to claim 1, wherein the processor executes the first authentication by a BIOS program, executes the second authentication by an OS logon program, and executes execution of the lock operation for the information processing apparatus by an OS service.

8. A lock execution method for information processing apparatus, comprising:
performing a first authentication based on input information from a user after an application of a power source;
preparing authentication information for a second authentication to be corresponded to the input information after the first authentication succeeds;
performing the second authentication using the prepared authentication information;
issuing a command to execute a lock operation for the information processing apparatus after the second authentication by the authentication succeeds; and
invalidating at least some of content of manipulation input during a period time until the lock operation is completed after the command is issued at the issuing.

9. A computer-readable storage medium storing a program that, when executed by a computer, performs a lock execution method for a information processing apparatus comprising:
performing a first authentication based on input information from a user after an application of a power source;
preparing authentication information for a second authentication to be corresponded to the input information after the first authentication succeeds;
performing the second authentication using the prepared authentication information;
issuing a command to execute a lock operation for the information processing apparatus after the second authentication succeeds; and
invalidating at least some of content of manipulation input during a period time until the lock operation is completed after the command is issued at the issuing.

10. A lock execution system in which an information processing apparatus used by a user and a server authenticating the user are connected by a communication network, the information processing apparatus comprising:
an authentication unit configured to perform a first authentication based on input information from a user after an application of a power source, prepare authentication information for a second authentication to be corresponded to the input information after the first authentication succeeds, and perform the second authentication using the prepared authentication information; and
a lock execution unit configured to issue a command to execute a lock operation for the information processing apparatus after the second authentication by the authentication unit succeeds and invalidate all or some of content of manipulation input during a period of time until the lock operation is completed after the command is issued.
